(19) United States
(12) Patent Application Publication
(10) Pub. No.: US 2019/0068458 A1
(43) Pub. Date: Feb. 28, 2019

(54) METHODS AND APPARATUS TO GENERATE USER INTERFACE VIRTUAL RESOURCE PROVISIONING REQUEST FORMS

(71) Applicant: VMware Inc., Palo Alto, CA (US)

(72) Inventors: Kiril Stefanov, Sofia (BG); Plamen Grigorov, Sofia (BG); Simona Mitrenova, Sofia (BG)

(21) Appl. No.: 15/692,598

(22) Filed: Aug. 31, 2017

(51) Int. Cl. H04L 12/24; G06F 9/50; G06F 9/455

(52) U.S. Cl. CPC H04L 41/22; G06F 9/5077; G06F 9/461; H04L 41/5051; G06F 9/45558

(57) ABSTRACT

Methods and apparatus for generating user interface request forms for provisioning virtual resources is disclosed. The method includes receiving a request for a virtual resource provisioning request form that is associated with a resource blueprint, determining the virtual resource provisioning request form and presenting the virtual resource provisioning request form for display, receiving initial virtual resource provisioning request form information in one or more fields of the virtual resource provisioning request form, determining whether to expand the virtual resource provisioning request form based on the initial virtual resource provisioning request form information, and receiving information that completes the input of information into the virtual resource provisioning request form. In response to a completion of the input of information into the virtual resource provisioning request form, the virtual resource is provisioned.

### FIELD OF THE DISCLOSURE

The present disclosure relates generally to cloud computing and, more particularly, to methods and apparatus to generate user interface virtual resource provisioning request forms.

### BACKGROUND

Virtualizing computer systems provide benefits such as an ability to execute multiple computer systems on a single hardware computer, replicating computer systems, moving computer systems among multiple hardware computers, and so forth.

“Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may include many processing units (e.g., servers). Other components of a cloud computing environment include storage devices, networking devices (e.g., switches), etc. Current cloud computing environment configuration relies on much manual user input and configuration to install, configure, and deploy the components of the cloud computing environment.

### BRIEF DESCRIPTION OF THE DRAWINGS

FIG. 1 depicts an example operating environment of a system for generating user interface virtual resource provisioning request forms.

FIG. 2 illustrates the operation of the example system for generating user interface virtual resource provisioning request forms according to one example.

FIG. 3 illustrates a user interface virtual resource provisioning request form generated for a non-advanced user according to one example.

FIG. 4A illustrates a user interface virtual resource provisioning request form page generated for an advanced user according to one example.

FIG. 4B illustrates a user interface virtual resource provisioning request form page generated for an advanced user according to one example.

FIG. 4C illustrates a user interface virtual resource provisioning request form page generated for an advanced user according to one example.

FIG. 5 illustrates an example generation of a multi-machine blueprint by the example blueprint manager of FIG. 1.

FIG. 6 illustrates an example implementation of a virtual appliance.

FIG. 7 depicts example components of a system for generating user interface virtual resource provisioning request forms.

FIG. 8 depicts a flowchart representative of computer readable instructions that may be executed to implement the operations of an example method for generating user interface virtual resource provisioning request forms.

FIG. 9A depicts a flowchart representative of computer readable instructions that may be executed to implement operations of an example method for generating user interface virtual resource provisioning request forms.

FIG. 9B depicts a flowchart representative of computer readable instructions that may be executed to implement operations of an example method for generating user interface virtual resource provisioning request forms.

FIG. 9C depicts a flowchart representative of computer readable instructions that may be executed to implement operations of an example method for generating user interface virtual resource provisioning request forms.

FIG. 9D depicts a flowchart representative of computer readable instructions that may be executed to implement operations of an example method for generating user interface virtual resource provisioning request forms.

FIG. 10 is a block diagram of an example processing platform capable of executing the example machine-readable instructions of FIGS. 8, 9A, 9B, 9C and 9D.

### DETAILED DESCRIPTION

Cloud computing is based on the deployment of many physical resources across a network, virtualizing the physical resources into virtual resources, and provisioning the virtual resources to perform cloud computing services and applications. Example systems for virtualizing computer systems are described in U.S. patent application Ser. No. 11/903,374, entitled “METHOD AND SYSTEM FOR MANAGING VIRTUAL AND REAL MACHINES,” filed Sep. 21, 2007, and granted as U.S. Pat. No. 8,171,485, U.S. Provisional Patent Application No. 60/919,965, entitled “METHOD AND SYSTEM FOR MANAGING VIRTUAL AND REAL MACHINES,” filed Mar. 26, 2007, and U.S. Provisional Patent Application No. 61/736,422, entitled “METHODS AND APPARATUS FOR VIRTUALIZED COMPUTING,” filed Dec. 12, 2012, all three of which are hereby incorporated herein by reference in their entirety.

Cloud computing platforms may provide many powerful capabilities for performing computing operations. However, taking advantage of these computing capabilities manually may be complex and/or require significant training and/or expertise. Prior techniques to providing cloud computing platforms and services often require customers to understand details and configurations of hardware and software resources to establish and configure the cloud computing platform. Methods and apparatus disclosed herein facilitate the management of virtual machine resources in cloud computing platforms.

A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example.

As disclosed in detail herein, methods and apparatus disclosed herein provide for automation of management tasks such as provisioning multiple virtual machines for a multiple-machine computing system (e.g., a group of servers that inter-operate), linking provisioned virtual machines and tasks to desired systems to execute those virtual machines or tasks, and/or reclaiming cloud computing resources that are no longer in use. The improvements to cloud management systems (e.g., the vCloud Automation Center (vCAC) from VMware®, the vRealize Automation Cloud Automation Software from VMware®), interfaces, portals, etc. disclosed herein may be utilized individually and/or in any combination. For example, all or a subset of the described improvements may be utilized.

As used herein, availability refers to the level of redundancy required to provide continuous operation expected for the workload domain. As used herein, performance refers to the computer processing unit (CPU) operating speeds (e.g., CPU gigahertz (GHz)), memory (e.g., gigabytes (GB) of random access memory (RAM)), mass storage (e.g., GB hard drive disk (HDD), GB solid state drive (SSD)), and power capabilities of a workload domain. As used herein, capacity refers to the aggregate number of resources (e.g., aggregate storage, aggregate CPU, etc.) across all servers associated with a cluster and/or a workload domain. In examples disclosed herein, the number of resources (e.g., capacity) for a workload domain is determined based on the redundancy, the CPU operating speed, the memory, the storage, the security, and/or the power requirements selected by a user. For example, more resources are required for a workload domain as the user-selected requirements increase (e.g., higher redundancy, CPU speed, memory, storage, security, and/or power options require more resources than lower redundancy, CPU speed, memory, storage, security, and/or power options).

### Example Virtualization Environments

Many different types of virtualization environments exist. Three example types of virtualization environment are: full virtualization, paravirtualization, and operating system virtualization. Full virtualization, as used herein, is a virtualization environment in which hardware resources are managed by a hypervisor to provide virtual hardware resources to a virtual machine. In a full virtualization environment, the virtual machines do not have direct access to the underlying hardware resources. In a typical full virtualization environment, a host operating system with embedded hypervisor (e.g., VMware ESXi®) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical random access memory (RAM) with virtual RAM). Typically, in full virtualization, the virtual machine and the guest operating system have no visibility and/or direct access to the hardware resources of the underlying server. Additionally, in full virtualization, a full guest operating system is typically installed in the virtual machine while a host operating system is installed on the server hardware. Example full virtualization environments include VMware ESX®, Microsoft Hyper-V®, and Kernel Based Virtual Machine (KVM).

Paravirtualization, as used herein, is a virtualization environment in which hardware resources are managed by a hypervisor to provide virtual hardware resources to a virtual machine and guest operating systems are also allowed direct access to some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

Operating system virtualization is also referred to herein as container virtualization. As used herein, operating system virtualization refers to a system in which processes are isolated in an operating system. In a typical operating system virtualization system, a host operating system is installed on the server hardware. Alternatively, the host operating system may be installed in a virtual machine of a full virtualization environment or a paravirtualization environment. The host operating system of an operating system virtualization system is configured (e.g., utilizing a customized kernel) to provide isolation and resource management for processes that execute within the host operating system (e.g., applications that execute on the host operating system). The isolation of the processes is known as a container. Several containers may share a host operating system. Thus, a process executing within a container is isolated from other processes executing on the host operating system. Thus, operating system virtualization provides isolation and resource management capabilities without the resource overhead utilized by a full virtualization environment or a paravirtualization environment. Alternatively, the host operating system may be installed in a virtual machine of a full virtualization environment or a paravirtualization environment. Example operating system virtualization environments include Linux Containers LXC and LXD, Docker™, OpenVZ™, etc.

In some instances, a data center (or pool of linked data centers) may include multiple different virtualization environments. For example, a data center may include hardware resources that are managed by a full virtualization environment, a paravirtualization environment, and an operating system virtualization environment. In such a data center, a workload may be deployed to any of the virtualization environments.

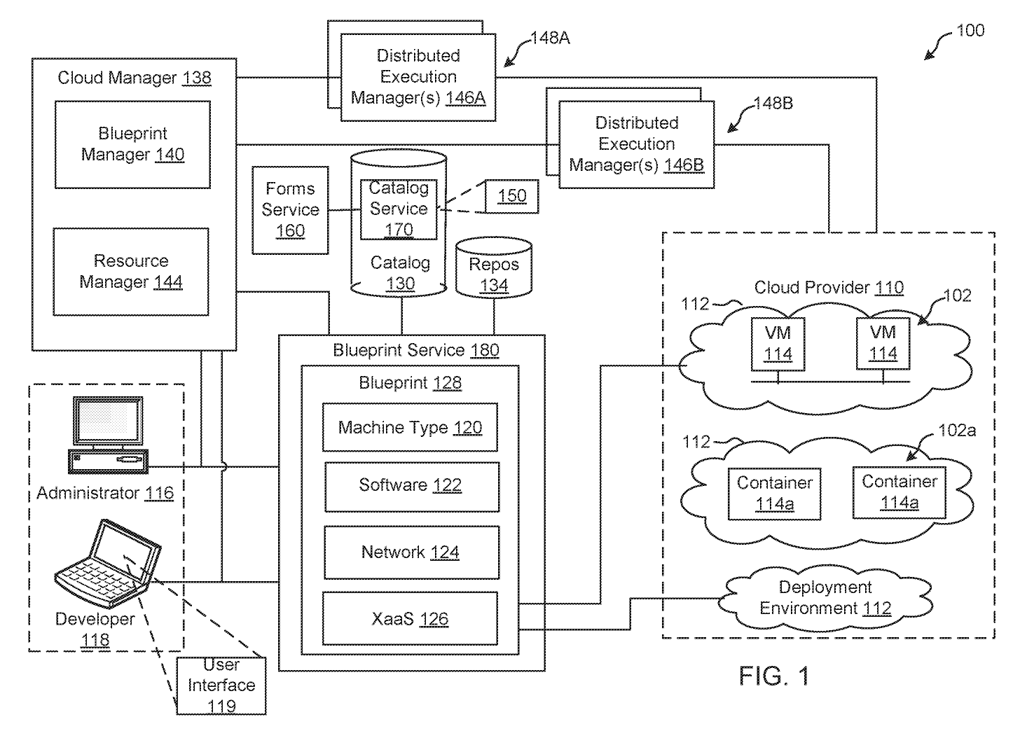

FIG. 1 depicts an example system 100 constructed in accordance with the teachings of this disclosure for managing a cloud computing platform. System 100 is an example operating environment of system 150 for generating virtual resource provisioning request forms. System 150 is described in more detail herein below. The example system 100 includes an application director 106 and a cloud manager 138 to manage a cloud computing platform provider 110 as described in more detail below. As described herein, the example system 100 facilitates management of the cloud provider 110 and does not include the cloud provider 110. Alternatively, the system 100 could be included in the cloud provider 110.

The cloud computing platform provider 110 provisions virtual computing resources (e.g., virtual machines, or “VMs,” 114) that may be accessed by users of the cloud computing platform 110 (e.g., users associated with an administrator 116 and/or a developer 118) and/or other programs, software, device. etc.

An example application 102 of FIG. 1 includes multiple VMs 114. The example VMs 114 of FIG. 1 provide different functions within the application 102 (e.g., services, portions of the application 102, etc.). One or more of the VMs 114 of the illustrated example are customized by an administrator 116 and/or a developer 118 of the application 102 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example cloud computing platform provider 110 may provide multiple deployment environments 112, for example, for development, testing, staging, and/or production of applications. The administrator 116, the developer 118, other programs, and/or other devices may access services from the cloud computing platform provider 110, for example, via REST (Representational State Transfer) APIs (Application Programming Interface) and/or via any other client-server communication protocol. Example implementations of a REST API for cloud computing services include a vCloud Administrator Center™ (vCAC) and/or vRealize Automation™ (vRA) API and a vCloud Director™ API available from VMware, Inc. The example cloud computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Also like virtual machines, the containers 114a can execute instances of applications or programs (e.g., an example application 102a) separate from application/program instances executed by the other containers in the same development environment 112.

A catalog 130 is a listing of available virtual computing resources (e.g., VMs, networking, storage, etc.) that may be provisioned from the cloud computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 128 may define one or more dependencies between application components to indicate an installation order of the application components during deployment. For example, since a load balancer usually cannot be configured until a web application is up and running, the developer 118 may specify a dependency from an Apache service to an application code package.

In one example, the catalog 130 can be associated with a catalog service 170 that includes a system 150 for generating virtual resource provisioning request forms. In some examples, the catalog service 170 can include a self-service portal that enables developers 118 or business users to request services (e.g., information technology (IT) services). The system 150 generates request forms that are customized based on the virtual resource provisioning experience level of a user (e.g., user of system 100 for managing cloud computing resources). In one example, as a part of generating virtual resource provisioning request forms, system 150, receives a request for a virtual resource provisioning request form that is associated with a resource blueprint (e.g., virtual machine). System 150 then determines how the virtual resource provisioning request form is to be organized and presents the virtual resource provisioning request form for display. After the virtual resource provisioning request form is displayed, system 150 can receive initial virtual resource provisioning request form inputs into one or more fields of the virtual resource provisioning request form. Based on these inputs, system 150 determines whether to expand the virtual resource provisioning request form (e.g., add optional fields). Thereafter, system 150 can receive data that completes the input of virtual resource provisioning information into fields of the virtual resource provisioning request form, and in response, provision the virtual resource, based on the virtual resource provisioning information/data. In some examples, properties of fields of the virtual resource provisioning request form can include but are not limited to label (name for field), description (information about the field), data type, display advice, permissible values, multivalued, not multivalued, dependencies and constraints. In some examples, the virtual resource provisioning information that is received in fields of the virtual resource provisioning request form can have the form of a value that can include but is not limited to string, integer, Boolean and complex values. In other examples, other values can be used. Types of fields that can be a part of the user interface that is provided to facilitate control of virtual resource provisioning can include but are not limited to text field, text area, drop-down, check box, radio group and searcher. In some examples, information/data can be multivalued or have only one value. In some examples, constraints on virtual resource provisioning information can include but are not limited to required, read only, default value, fixed value, minimum value, maximum value and regular expression. In some examples, dependencies between properties of the request schema (the data that needs to be provided via a request form in order to request a blueprint for a particular virtual resource) are identified. In some examples, if values of identified properties change, the user can consult a linked “state” resource for an updated state of the field.

The system 150 enables users, developers, business users, etc., to request information technology (IT) services and assist in the management of cloud and IT resources, while ensuring compliance with business policies. Requests for IT services, including infrastructure, applications, desktops, etc., can be processed through a catalog service 170 to provide a consistent user experience.

A blueprint service 180 causes/triggers/facilitates the provisioning of a virtual resource based on the information input by a user into a virtual resource provisioning request form for provisioning of the virtual resource. The provisioning of the virtual resource is performed in accordance with logic in the blueprint that is associated with the virtual resource. The blueprint service 180 causes the provisioning of the virtual resource by communicating provisioning information to the cloud computing platform provider 110 in order to cause computing platform provider 110 to provision specified virtual resources (e.g., VMs 114) in the deployment environment 112. In some examples, the blueprint service 180 causes the provisioning of a virtual resource responsive to the completion of the filling of the fields of a virtual resource provisioning request form. In some examples, virtual resource administrators 116 can create the blueprints that define machine deployment settings. In some examples, published (e.g., previously created) blueprints become catalog items, and can be used to provision machine deployments. In some examples, catalog items range in complexity from a single, simple machine with no guest operating system to complex custom application stacks delivered on multiple machines under a load balancer with networking and security controls. In some examples, as a part of operation, blueprint service 180 allows administrators 116, developers 118 and other authorized users to select a virtual resource machine type 120, software type 122, network 124 and XaaS 126 for the blueprint associated with a virtual resource that is to be provisioned. In some examples, the XaaS 126 enables additional customization of machine and software components of the blueprint.

Examples enable the automatic generation of user interface (UI) virtual resource provisioning request forms for provisioning virtual computing resources in a computing environment such as the VM 114, etc. The generation of the virtual resource provisioning request forms is dynamic. For example, the virtual resource provisioning request forms are produced based on automated processes. Initially, simplified forms are produced that are expandable at request time, based upon a user's choice, whether field parameters are required or optional, and/or dependencies between them. In some examples, hints can be displayed as popups in the UI in order to provide guidance to users while filling the request form. The systems and methods can be applied to any blueprint. Examples also can trigger different form validations based on the fields that are currently visible on the screen. Blueprint definitions describe the provisioning flow and schema of input parameters that are used to trigger provisioning requests.

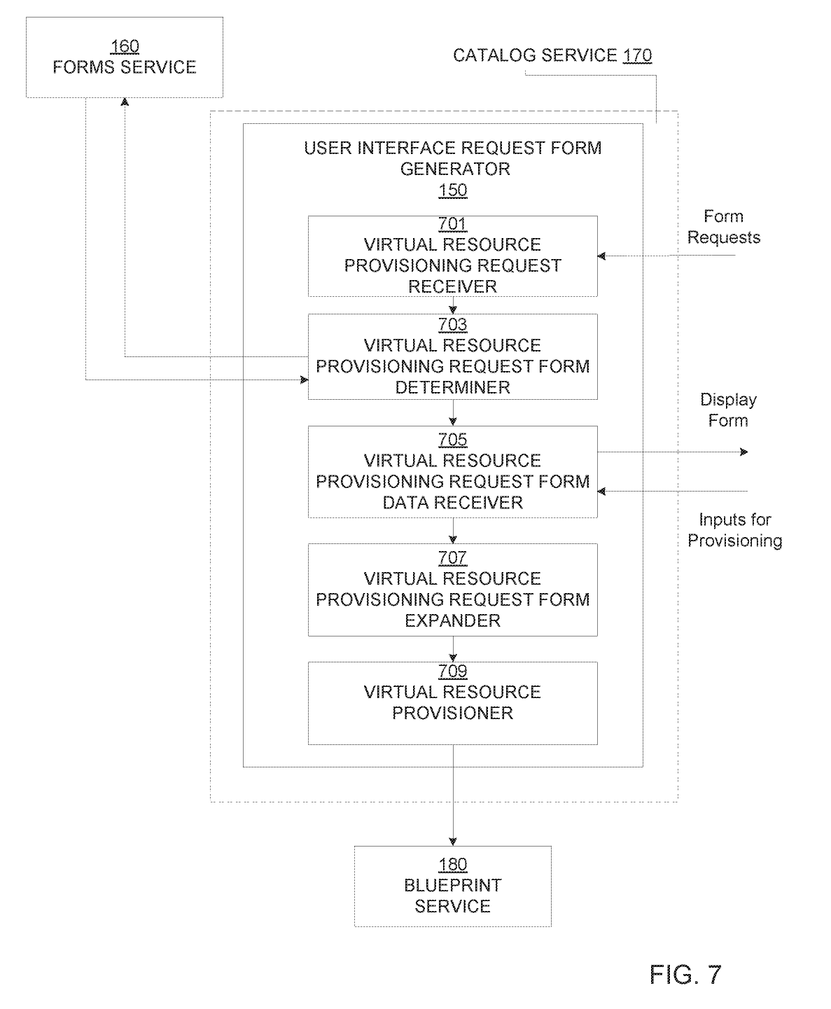

A forms service 160 generates and stores virtual resource provisioning request forms. In one example, when a user/form requestor requests a virtual resource provisioning request form in order to provision a virtual resource to include a particular type of machine, software, network and security, container and/or XaaS, then fields associated with a blueprint 128 for a virtual resource that includes those components are examined for inclusion in the virtual resource provisioning request form. In addition, the fields that are included in the virtual resource provisioning request form that is presented to the form requestor are based on whether the form requester is an advanced user or a non-advanced user. The manner in which the system 150 determines whether a user is advanced or non-advanced is discussed with regard to FIG. 7. In some examples, after a virtual resource provisioning request form has been generated for provisioning a virtual resource, the virtual resource provisioning request form can be stored by the forms service 160 for subsequent retrieval. This enables users that desire a similar provisioning to access forms that have been previously generated for such provisioning such that their provisioning request does not require the regeneration of such forms.

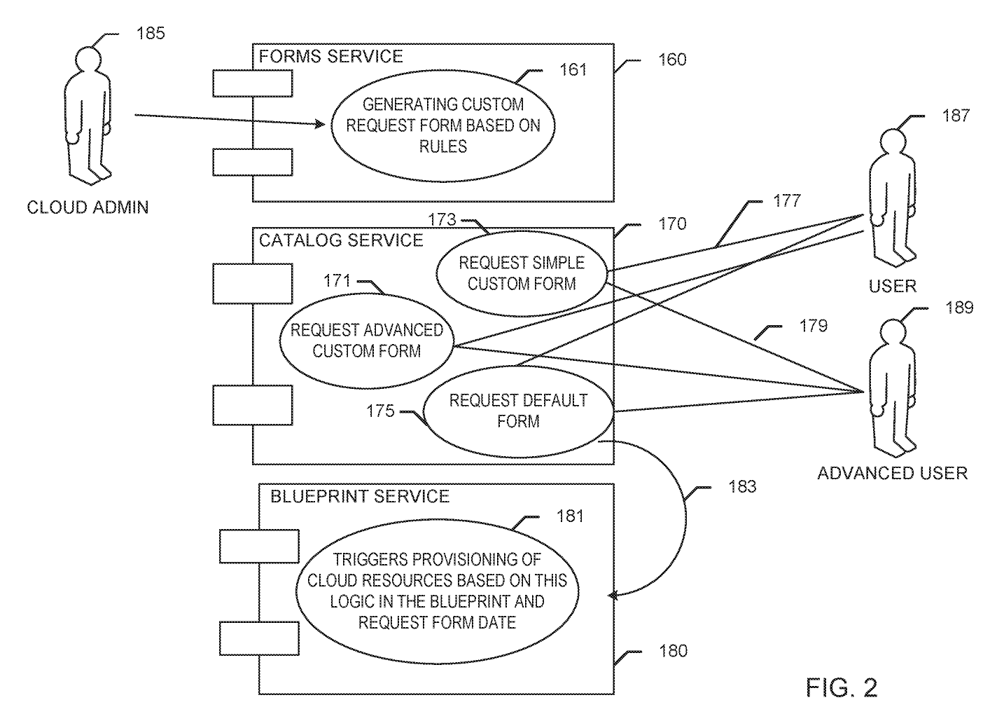

FIG. 2 illustrates the operation of the system 150. Initially, users 187 and 189 can make a request for a virtual resource provisioning request form, 177 and 179, at a portal associated with the catalog service 170. In some examples, users 187 and 189 can request an advanced custom virtual resource provisioning request form 171, a non-advanced custom virtual resource provisioning request form 173 or a default virtual resource provisioning form 175. In some examples, the advanced custom virtual resource provisioning request form 171 is for advanced users and the non-advanced custom virtual resource provisioning request form 173 is for non-advanced users. As used herein the terms advancement level or experience level are intended to refer to a user's level of knowledge and skill related provisioning virtual resources on the platform 100. The advanced custom virtual resource provisioning request form 171 and the non-advanced custom request form 173 are generated automatically and are customized in accordance with the provisioning request. In some examples, the default virtual resource provisioning form 175 is a static form that is the same for all blueprints and may be requested in lieu of the advanced custom virtual resource provisioning request form 171 and the non-advanced custom request form 173. In some examples, the system 150 can determine the advancement level of a user based on a maintained user profile. In some examples, the system 150 can determine the advancement level of a user based on a configuration that the user has made (for example as part of a preferences designation in a user browser). In some examples, the system 150 can determine the advancement level of a user by tracking a user's behavior (e.g., with regard to virtual resource provisioning request forms, overall system usage, etc.) and using the data obtained as part of the tracking to determine the advancement level of the user.

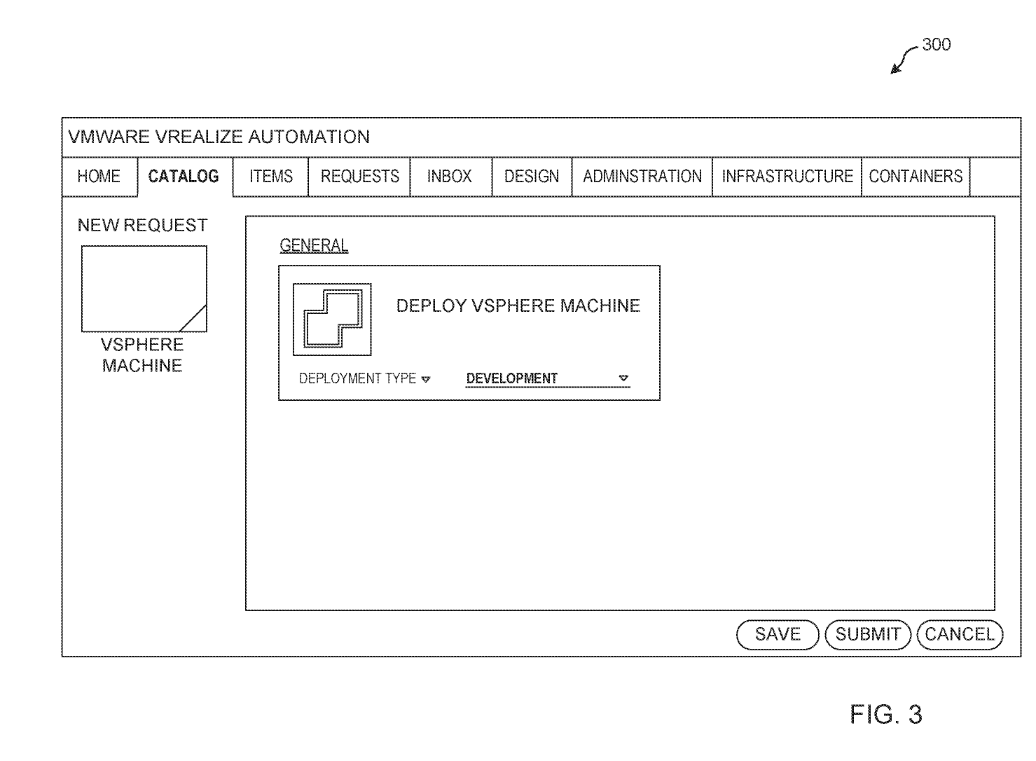

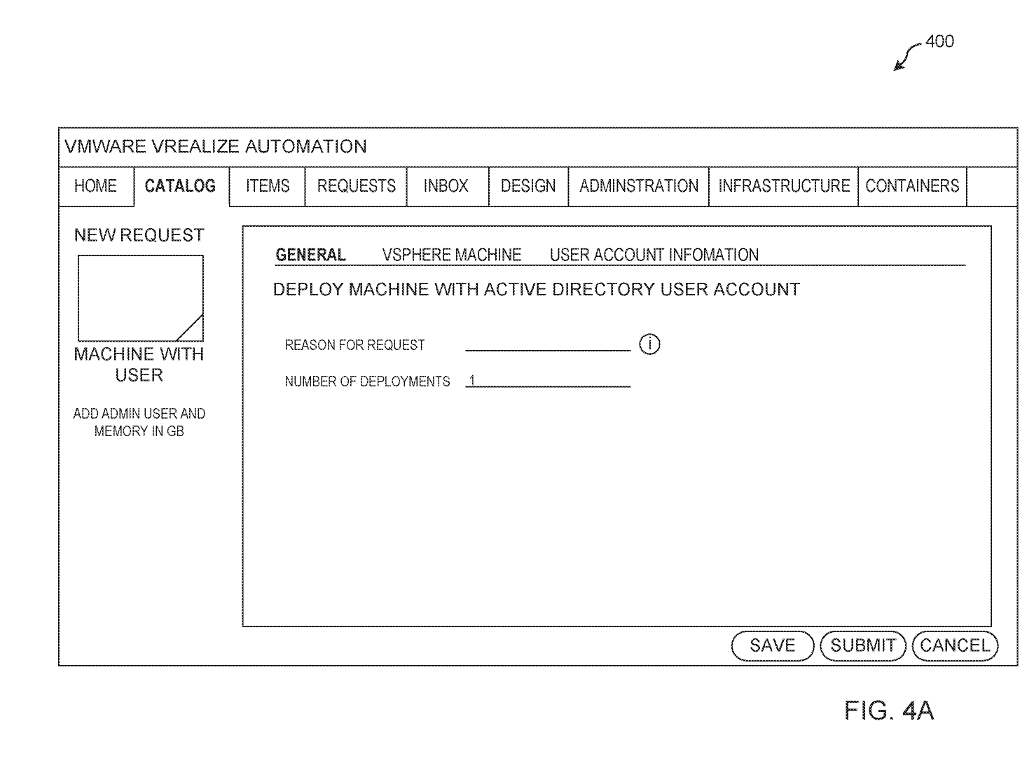

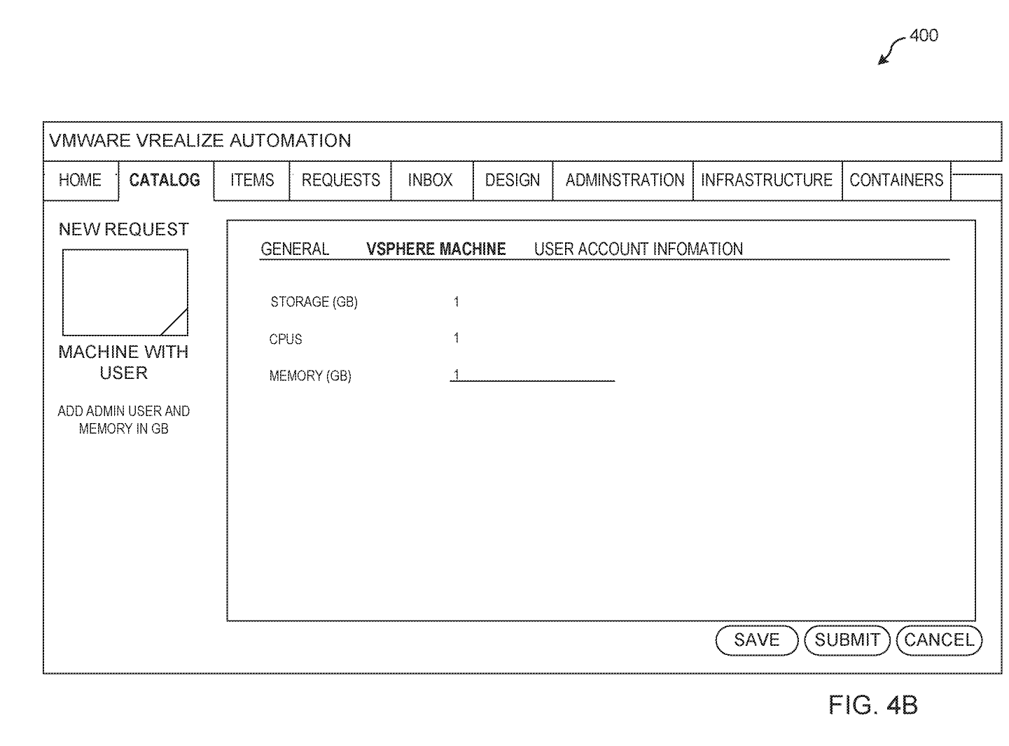

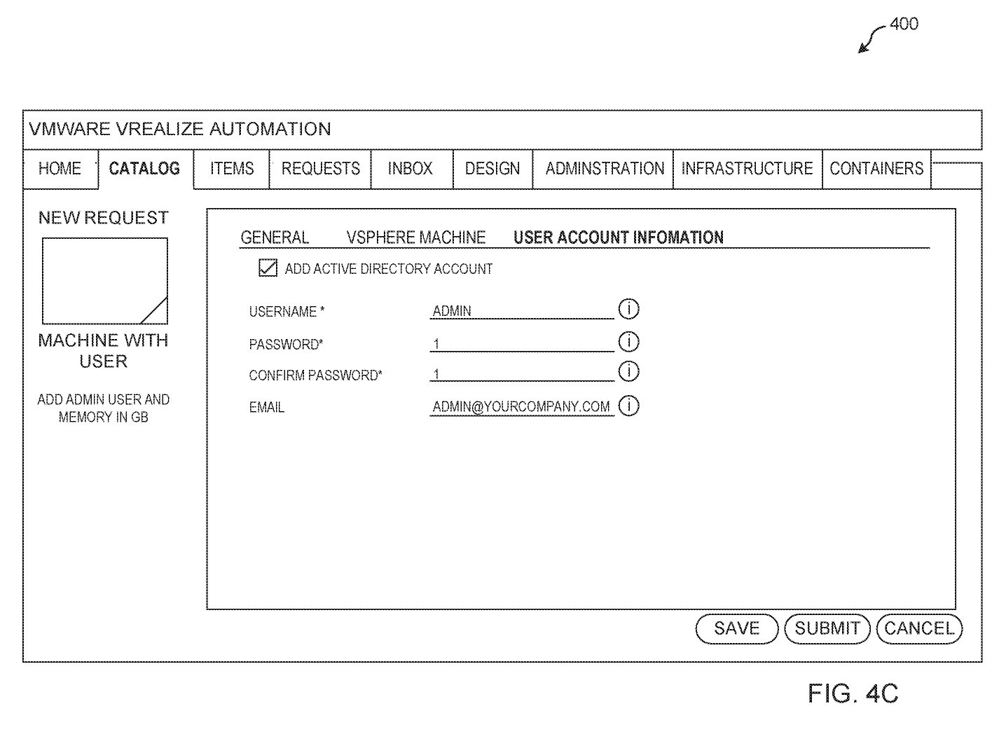

Referring again to FIG. 2, based upon the blueprint 128 that is associated with the virtual resource provisioning request form that is requested, a virtual resource provisioning request form 171, 173, or 175 is generated 161 by forms service 160 and displayed to the user via a portal of the catalog service 170. When the virtual resource provisioning request form is filled and a provisioning request based thereupon has been completed, the blueprint service 180 triggers the provisioning of the virtual resource based on the request form data and the logic in the blueprint 128. FIG. 3 shows an example simplified (non-advanced level) virtual resource provisioning request form 300 (e.g., 173 in FIG. 2) generated for a non-advanced user as part of the operation of system 150. The virtual resource provisioning request form 300 includes only fields that require user input of data (e.g., fields in which the input of data by the user is mandatory). Fields with default constraints, read only constraints and fixed value constraints are not included in the virtual resource provisioning request form 300. As such, a non-advanced user desiring to provision a virtual resource can do so using an uncomplicated virtual resource provisioning form such as the virtual resource provisioning request form 300. FIGS. 4A, 4B and 4C show example pages of a virtual resource provisioning request form 400 (e.g., 171 in FIG. 2) generated for an advanced user as a part of the operation of system 150. Referring to FIGS. 4A, 4B and 4C, FIG. 4A shows an example general provisioning request page of form 400, FIG. 4B shows a provisioning request page of form 400 for machine provisioning information, and FIG. 4C shows a provisioning request page of form 400 for user account information. The virtual resource provisioning request form 400 can include mandatory fields, fields that have default constraints and fields that have read only constraints, for example. In some examples, a default value constraint, e.g., “ADMIN” (for administrator) can be assigned as a default value for a field, e.g., a “Username” field, but can be changed by a user. Additionally, fields that are associated with optional features can be made visible. Thus, an advanced user is provided with the full range of options for provisioning a virtual resource. In some examples, several types of constraints can be associated with a field and include but are not limited to: (1) read-only constraints where fields having such constraints are shown on the form but cannot be edited, e.g., “account domain name,” (2) fixed-value constraints where fields containing such constraints are predefined by the system and in some examples do not appear in the request form; although the value of the constraint is used in the resource provisioning process, for example, the business group of the logged-in user, (3) minimum and maximum value constraints that are used to define a range limit of a value, e.g., “number of deployments,” and (4) regex constraints that define custom field validation using a regular expression.

In one example, generated virtual resource provisioning request forms can be stored such that they can be retrieved for future request for the same form. The system 150 enables the customization of forms for user experience levels that can range from advanced to novice (non-advanced). For example, the system 150 eliminates the inclusion of fields that are not mandatory to execute a provisioning of a virtual resource such that non-advanced users can readily execute such provisioning without having to worry about completing the non-mandatory fields (e.g., “deployment description,” “reason for request,” “user title” or “secondary name”).

Referring again to FIG. 1, the example cloud manager 138 of FIG. 1 interacts with the components of the system 100 (e.g., an application director and the cloud provider 110) to facilitate the management of the resources of the cloud provider 110. The example cloud manager 138 includes a blueprint manager 140 to facilitate the creation and management of multi-machine blueprints and a resource manager 144 to reclaim unused cloud resources. The cloud manager 138 may additionally include other components for managing a cloud environment.

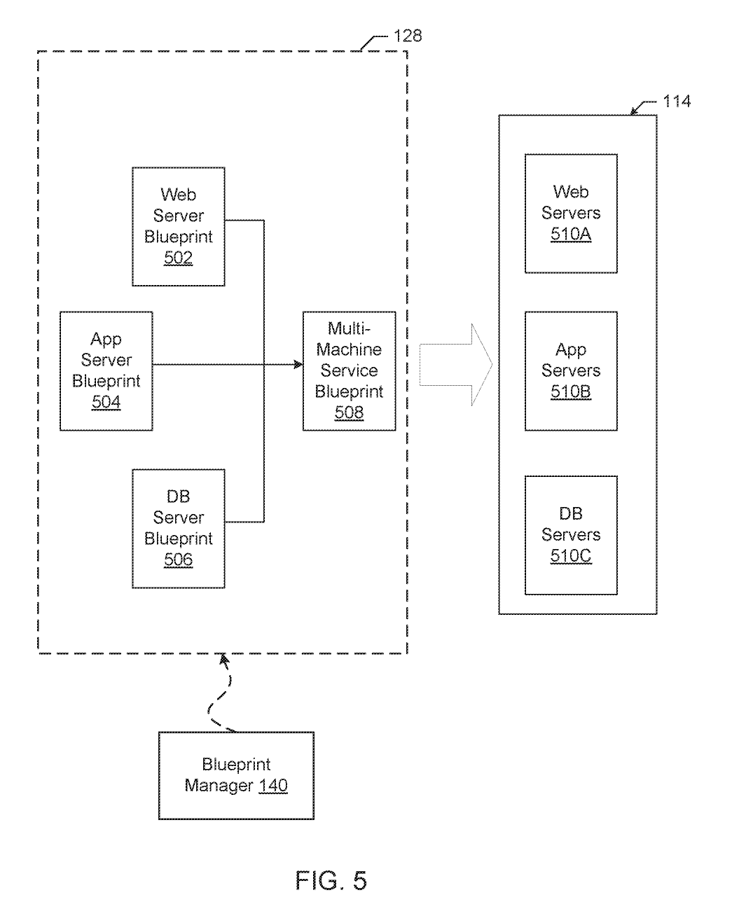

The example blueprint manager 140 of the illustrated example manages the creation of multi-machine blueprints that define the attributes of multiple virtual machines as a single group that can be provisioned, deployed, managed, etc., as a single unit. For example, a multi-machine blueprint may include definitions for multiple basic blueprints that make up a service (e.g., an e-commerce provider that includes web servers, application servers, and database servers, etc.). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually. Example management of multi-machine blueprints 128 is described in further detail in conjunction with FIG. 5.

The example blueprint manager 140 of FIG. 1 additionally annotates basic blueprints and/or multi-machine blueprints 128 to control how workflows associated with the basic blueprints and/or multi-machine blueprints 128 are executed. As used herein, a workflow is a series of actions and decisions to be executed in a virtual computing platform (e.g., cloud provider 110). The example system 100 includes first and second distributed execution manager(s) (DEM(s)) 146A and 146B to execute workflows. According to the illustrated example, the first DEM 146A includes a first set of characteristics and is physically located at a first location 148A. The second DEM 146B includes a second set of characteristics and is physically located at a second location 148B. The location and characteristics of a DEM (e.g., 146A or 146B) may make that DEM more suitable for performing certain workflows. For example, a DEM (e.g., 146A or 146B) may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM (e.g., 146A or 146B) that is labeled with the same or similar capabilities.

The resource manager 144 of the illustrated example facilitates recovery of cloud computing resources of the cloud provider 110 that are no longer being actively utilized. Automated reclamation may include identification, verification and/or reclamation of resources that are unused, underutilized, etc. to improve the efficiency of the running cloud infrastructure.

FIG. 5 illustrates an example implementation of a blueprint 128 as a multi-machine blueprint generated by the example blueprint manager 140 of FIG. 1. In the illustrated example of FIG. 5, three example basic blueprints (a web server blueprint 502, an application server blueprint 504, and a database (DB) server blueprint 506) have been created (e.g., by the topology generator 120). For example, the web server blueprint 502, the application server blueprint 504, and the database server blueprint 506 may define the components of an e-commerce online store.

The example blueprint manager 140 provides a user interface for a user of the blueprint manager 140 (e.g., the administrator 116, the developer 118, etc.) to specify blueprints (e.g., basic blueprints and/or multi-machine blueprints) to be assigned to an instance of a multi-machine blueprint 508. For example, the user interface may include a list of previously generated basic blueprints (e.g., the web server blueprint 502, the application server blueprint 504, the database server blueprint 506, etc.) to allow selection of desired blueprints. The blueprint manager 140 combines the selected blueprints into the definition of the multi-machine blueprint 508 and stores information about the blueprints in a multi-machine blueprint record defining the multi-machine blueprint 508. The blueprint manager 140 may additionally include a user interface to specify other characteristics corresponding to the multi-machine blueprint 508. For example, a creator of the multi-machine blueprint 508 may specify a minimum number and a maximum number of each blueprint component of the multi-machine blueprint 508 that may be provisioned during provisioning of the multi-machine blueprint 508.

Accordingly, any number of virtual machines 114 (e.g., the virtual machines associated with the blueprints in the multi-machine blueprint 508) and/or containers may be managed collectively. For example, the multiple virtual machines corresponding to the multi-machine blueprint 508 may be provisioned based on an instruction to provision the multi-machine blueprint 508, may be power cycled by an instruction, may be shut down by an instruction, may be booted by an instruction, etc. As illustrated in FIG. 5, an instruction to provision the multi-machine blueprint 508 may result in the provisioning of a multi-machine service formed from one or more VMs 114 that includes virtualized web server(s) 510A, virtualized application server(s) 510B, and virtualized database server(s) 510C. The number of virtual machines and/or containers provisioned for each blueprint may be specified during the provisioning of the multi-machine blueprint 508 (e.g., subject to the limits specified during creation or management of the multi-machine blueprint 508).

The multi-machine blueprint 508 maintains the reference to the basic blueprints 502, 504, 506. Accordingly, changes made to the blueprints (e.g., by a manager of the blueprints different than the manager of the multi-machine blueprint 508) may be incorporated into future provisioning of the multi-machine blueprint 508. Accordingly, an administrator maintaining the source blueprints (e.g., an administrator charged with managing the web server blueprint 502) may change or update the source blueprint and the changes may be automatically propagated to the machines provisioned from the multi-machine blueprint 508. For example, if an operating system update is applied to a disk image referenced by the web server blueprint 502 (e.g., a disk image embodying the primary disk of the web server blueprint 502), the updated disk image is utilized when deploying the multi-machine blueprint. Additionally, the blueprints may specify that the machines 510A, 510B, 510C of the multi-machine service 510 provisioned from the multi-machine blueprint 508 operate in different environments. For example, some components may be physical machines, some may be on-premise virtual machines, and some may be virtual machines at a cloud service, etc.

Several multi-machine blueprints 128 may be generated to provide one or more varied or customized services. For example, if virtual machines 114 deployed in the various States of the United States require different settings, a multi-machine blueprint 128 can be generated for each state. The multi-machine blueprints 128 can reference the same build profile and/or disk image, but may include different settings specific to each state. For example, the deployment workflow may include an operation to set a locality setting of an operating system to identify a particular state in which a resource is physically located. Thus, a single disk image may be utilized for multiple multi-machine blueprints 128 reducing the amount of storage space for storing disk images compared with storing a disk image for each customized setting, for example.

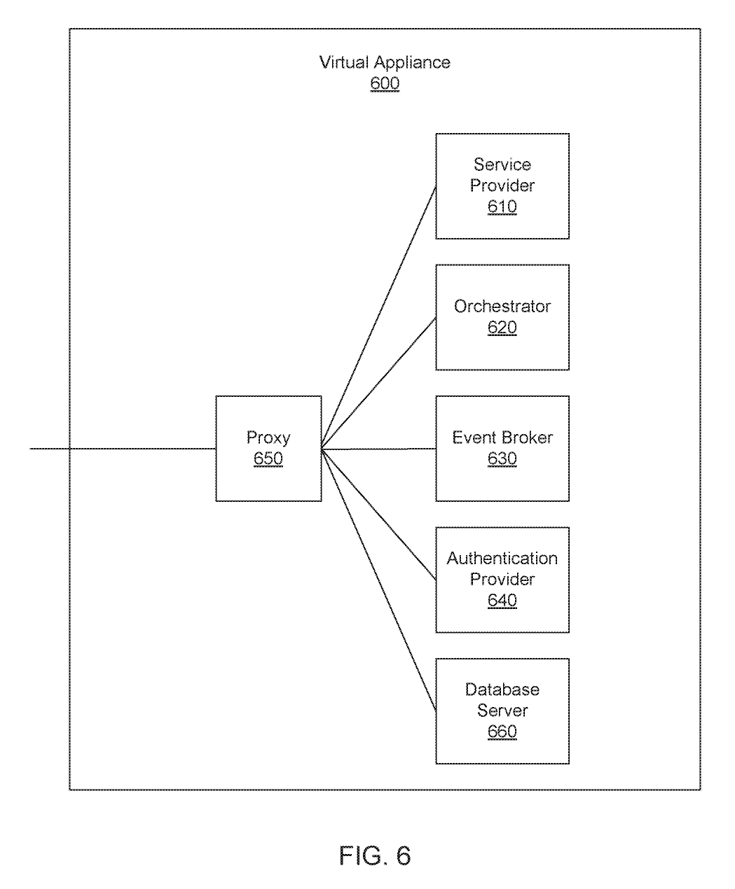

FIG. 6 illustrates an example implementation of a virtual appliance—vA 600. In the example of FIG. 6, the vA 600 includes a service provider 610, an orchestrator 620, an event broker 630, an authentication provider 640, an internal reverse proxy 650, and a database 660. The components 610, 620, 630, 640, 650, 660 of the vA 320 may be implemented by one or more of the VMs 114. The example service provider 610 provides services to provision interfaces (e.g., Web interface, application interface, etc.) for the vA 320. The example orchestrator (e.g., vCO) 620 is an embedded or internal orchestrator that can leverage a provisioning manager, such as the cloud manager 138, to provision VM services but is embedded in the vA 600. For example, the vCO 620 can be used to invoke a blueprint to provision a manager for services.

Example services can include catalog services 170, forms services 160, blueprint services 180, identity services, component registry services, event broker services, IaaS, XaaS, etc. Catalog services 170 provide a user interface via which a user can request provisioning of different preset environments (e.g., a VM 114 including an operating system and software and some customization, etc.), for example. Identity services facilitate authentication and authorization of users and assigned roles, for example. The component registry maintains information corresponding to installed and deployed services (e.g., uniform resource locators for services installed in a VM/vA, etc.), for example. The event broker provides a messaging broker for event-based communication, for example. The IaaS provisions one 630 or more VMs and/or containers for a customer via the vA 600. The XaaS can extend the provisioning to also request, approve, provision, operate, and decommission any type of catalog items (e.g., storage, applications, accounts, and anything else that the catalog provides as a service).

The example event broker 630 provides a mechanism to handle tasks which are transferred between services with the orchestrator 620. The example authentication provider 640 (e.g., VMware Horizon™ services, etc.) authenticates access to services and data, for example.

The components of the vA 600 access each other through representational state transfer (REST) API calls behind the internal reverse proxy 650 (e.g., a high availability (HA) proxy HAProxy) which provides a high availability load balancer and proxy for Transmission Control Protocol (TCP)- and Hypertext Transfer Protocol (HTTP)-based application requests. In this example, the proxy 650 forwards communication traffic from within the vA 600. In certain examples, services access the local host/proxy 650 on a particular port, and the call is masked by the proxy 650 and forwarded to the particular component of the vA 600. Since the call is masked by the proxy 650, components can be adjusted within the vA 600 without impacting outside users.

FIG. 7 illustrates components of an example implementation of the system 150 for generating user interface virtual resource provisioning request forms. Example components of the system 150 include virtual resource provisioning request receiver 701, virtual resource provisioning request form determiner 703, virtual resource provisioning request form data receiver 705, virtual resource provisioning request form expander 707 and virtual resource provisioner 709.

The virtual resource provisioning request receiver 701 receives a request for a virtual resource provisioning request form (e.g., 171, 173 or 175) that is associated with a resource blueprint 128. In one example, virtual resource provisioning request receiver 701 receives requests that are input to a user interface, such as a user interface of a virtual resource management system (e.g., 100). In one example, the request can be made by a user, such as a user desiring to provision a virtual resource. In one example, the user can enter data into a field or fields of the user interface 119 of the virtual resource management system, in order to make the request for the virtual resource provisioning request form (e.g., 171, 173 or 175). In one example, the user can be an advanced user or a non-advanced user. In one example, an advanced user may have advanced knowledge related to provisioning virtual resources using a virtual resource management system. In one example, a non-advanced user may have less advanced knowledge of provisioning virtual resources using a virtual resource management system (e.g., 100). In one example, the input initiates an automated virtual resource provisioning request form retrieval/generation process.

The virtual resource provisioning request form determiner 703 determines the fields that are to be included in a virtual resource request form (e.g., 171, 173 or 175) and the organization of the virtual resource request form that is to be presented to a user/form requester. The virtual resource provisioning request form (e.g., 171, 173 or 175) that is produced in this process is then provided for display via user interface 119 (FIG. 1) to the user/form requestor. In one example, the fields that are to be included in the virtual resource provisioning request form (e.g., 171, 173 or 175) are based on the blueprint 128 that is associated with the request for the virtual resource provisioning request form (e.g., 171, 173 or 175). In some examples, as shown in FIG. 7, the virtual resource provisioning request form determiner 703 can access forms service 160 to determine the fields that are associated with a blueprint 128. For example, if the form requestor 187, 189 (FIG. 2) is requesting a virtual resource provisioning request form (e.g., 171, 173 or 175) in order to provision a virtual resource that includes a particular type of machine, software, network and security, containers and XaaS, then fields associated with a blueprint 128 for a virtual resource that includes those components are examined for inclusion in the virtual resource provisioning request form (e.g., 171, 173 or 175). In one example, the fields that are included in the virtual resource provisioning request form (e.g., 171, 173 or 175) that is presented to the form requestor 187, 189 (FIG. 2) is based on whether the form requester is an advanced user 189 or a non-advanced user 187. In some examples, whether a user is considered to be advanced or non-advanced is based on user input such as a designation by the user or system administrator. In some examples, whether a user is considered to be advanced or non-advanced is automatically determined and can be based on user profiles, the analysis of user data, etc. In one example, forms for advanced users can include the full range of available fields except those fields that have a fixed value constraint. An advanced user 189 can then be provided with the full range of options for provisioning a virtual resource. In one example, forms for non-advanced users may only include fields that require user input of information. For example, a form for a non-advanced user can include only mandatory fields. As such, a non-advanced user can provision a virtual resource using an uncomplicated virtual resource provisioning form (e.g., 300 in FIG. 3). In some examples, field types available for inclusion in a virtual resource provisioning request form include fields that require user input of information (e.g., mandatory), fields having a fixed value constraint(s), fields having a default constraint and fields that have read only constraints. Fields that require user input of information must be filled by users. Fields having fixed value constraints are filled with a value that cannot be changed. Fields having default constraints are filled automatically with default values that can be changed. Fields that have read only constraints are fields that are filled with values that can be read but not changed. In some examples, it is useful to make read only fields and their values visible to users as this information can be useful to a user for resource provisioning purposes. Optional fields are fields of a virtual resource provisioning request form that correspond to optional features of a blueprint configuration. In some examples, a checkbox can be generated that enables a user to select if an optional field is to be included in a virtual resource provisioning request form. In other examples, any suitable manner of determining if optional fields are to be included in a virtual resource provisioning request form can be used. The virtual resource provisioning request form determiner 703 determines the fields that are to be included in virtual resource provisioning request forms (e.g., 171, 173 or 175) and the appearance of virtual resource provisioning request forms (e.g., 171, 173 or 175) such that users are presented with forms whose makeup and appearance are tailored or customized to their level of experience or advancement related to virtual resource provisioning. In some examples, virtual resource provisioning request forms (e.g., 171, 173 or 175) related to a blueprint 128 that have been previously generated can be stored so that they do not have to be regenerated if a subsequent request for the same form is made. In some examples, a cloud administrator 116 can modify a plan upon which the previously generated form is based such that the previously generated form becomes invalid. In such cases, the simplified and advanced forms for the plan are regenerated based on the modified plan. The produced forms enable virtual resource provisioning requests to be made readily by users having a variety of levels of advancement and/or experience related to virtual resource provisioning requests.

The virtual resource provisioning request form data receiver 705 receives initial virtual resource provisioning request form inputs from one or more fields of the virtual resource provisioning request form (e.g., 171, 173 or 175). In some examples, the inputs provide information related to the provisioning and can include data that indicates whether the form should be expanded. For example, the initial inputs can indicate that optional components are to be provisioned. In some examples, virtual resource provisioning request form data receiver 705 receives inputs that can be used to determine the configuration of the fields of the virtual resource provisioning request form (e.g., 171, 173 or 175).

Virtual resource provisioning request form expander 707 determines whether to expand the virtual resource provisioning request form (e.g., 171, 173 or 175) based on the initial virtual resource provisioning request form input. Virtual resource provisioning request form expander 707 receives information from the virtual request form data receiver 705 and determines if the virtual resource provisioning request form (e.g., 171, 173 or 175) is to be expanded. For example, if initial input into the virtual resource provisioning request form (e.g., 171, 173 or 175) indicates that the user/requester desires the inclusion of optional components, then the virtual resource provisioning request form expander 707 can identify fields corresponding to the optional components and expand the virtual provisioning request form to include those fields. In one example, the optional fields can include fields that require user input of information (e.g., mandatory, etc.), fields having a fixed value constraint(s), fields having a default constraint, and fields that have read only constraints, etc. In some examples, optional components can themselves have optional components that have corresponding fields. In some examples, the capacity to expand virtual resource provisioning request forms (e.g., 171, 173 or 175) extends the advantages of the automated virtual resource provisioning request form production described herein to optional components. In addition, the capacity to expand the virtual resource provisioning request form (e.g., 171, 173 or 175) adds an additional level of automation to the automated virtual resource provisioning request form production described herein. The user/requester can complete a virtual resource provisioning request by entering information (e.g., values) into the fields that were added by the expanding of the virtual resource provisioning request form and trigger (e.g., through user interaction with the form interface graphics, etc.) an instantiation of the operation of virtual resource provisioner 709 based on the completed form.

The virtual resource provisioner 709 provides provisioning information to the blueprints service 180 in order to cause the provisioning of a virtual resource based on the provisioning information that is entered into the fields of the virtual resource provisioning request form by the user/form requester/provisioner. The virtual resource provisioner 709 can provide the provisioning information upon accessing the information from the completed virtual resource provisioning request form (e.g., 171, 173 or 175). Provisioning a virtual resource can include but is not limited to operations such as determining a specific type of virtual machine, operating system, hardware configuration, etc. for deployment. The provisioned virtual resource is deployed as directed by the virtual resource provisioner 709. The virtual resource provisioner 709 facilitates the provisioning of virtual resources whose provisioning is originated by either advanced or non-advanced provisioners.

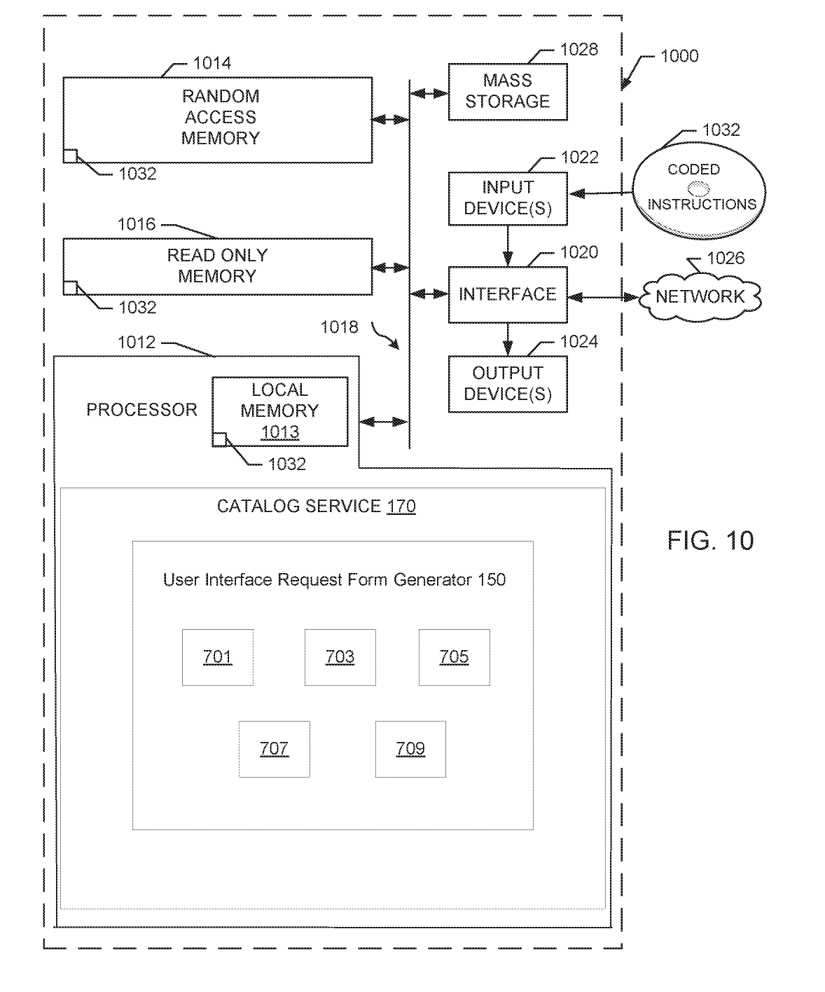

While an example implementation of the example generation of user interface virtual resource provisioning request forms of FIG. 1 is illustrated in FIG. 7, one or more of the elements, processes and/or devices illustrated in FIG. 7 may be combined, divided, re-arranged, omitted, eliminated and/or implemented in any other way. Further, the example virtual resource provisioning request receiver 701, the example virtual resource provisioning request form determiner 703, the example virtual resource provisioning request form data receiver 705, the example virtual resource provisioning request form expander 707 and the example virtual resource provisioner 709, and/or, more generally, the example system 150 illustrated in FIGS. 1 and 7 can be implemented by hardware, software, firmware and/or any combination of hardware, software and/or firmware. Thus, for example, any of the example virtual resource provisioning request receiver 701, the example virtual resource provisioning request form determiner 703, the example virtual resource provisioning request form data receiver 705, the example virtual resource provisioning request form expander 707 and the example virtual resource provisioner 709 and/or, more generally, the example system 150 of FIGS. 1 and 7 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example virtual resource provisioning request receiver 701, the example virtual resource provisioning request form determiner 703, the example virtual resource provisioning request form data receiver 705, the example virtual resource provisioning request form expander 707 and the example virtual resource provisioner 709 and/or, more generally, the example systems 150 of FIGS. 1 and 7 is/are hereby expressly defined to include a tangible computer readable storage device or storage disk such as a memory, a digital versatile disk (DVD), a compact disk (CD), a Blu-ray disk, etc. storing the software and/or firmware. Further still, the example virtual resource provisioning request receiver 701, the example virtual resource provisioning request form determiner 703, the example virtual resource provisioning request form data receiver 705, the example virtual resource provisioning request form expander 707 and the example virtual resource provisioner 709, and/or, more generally, the example system 150 of FIGS. 1 and 7 may include one or more elements, processes and/or devices in addition to, or instead of, those illustrated in FIG. 10, and/or may include more than one of any or all of the illustrated elements, processes and devices.

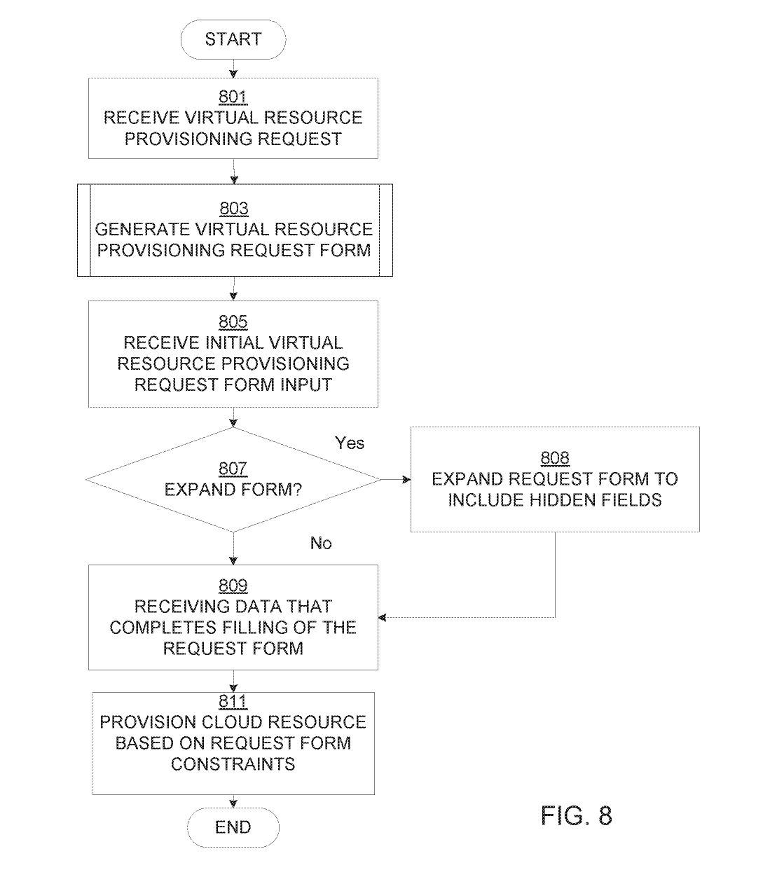

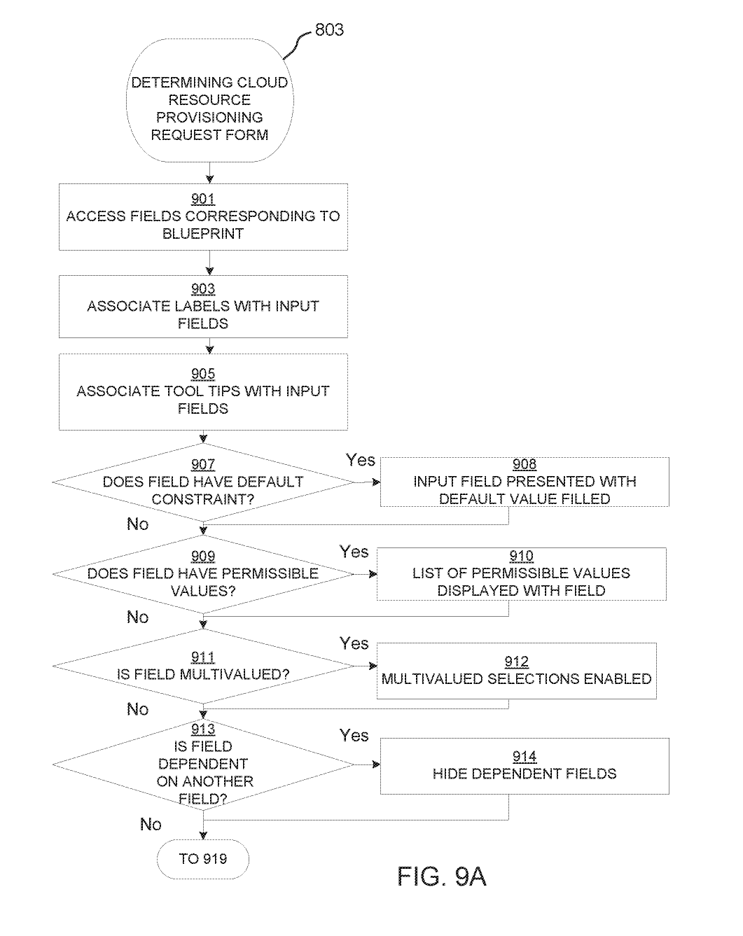

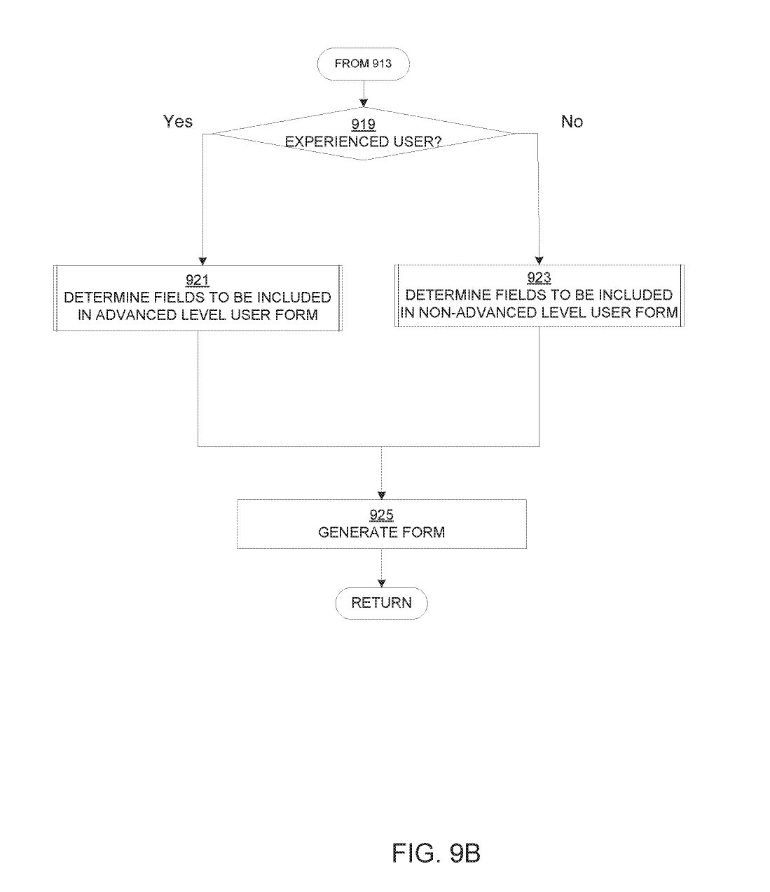

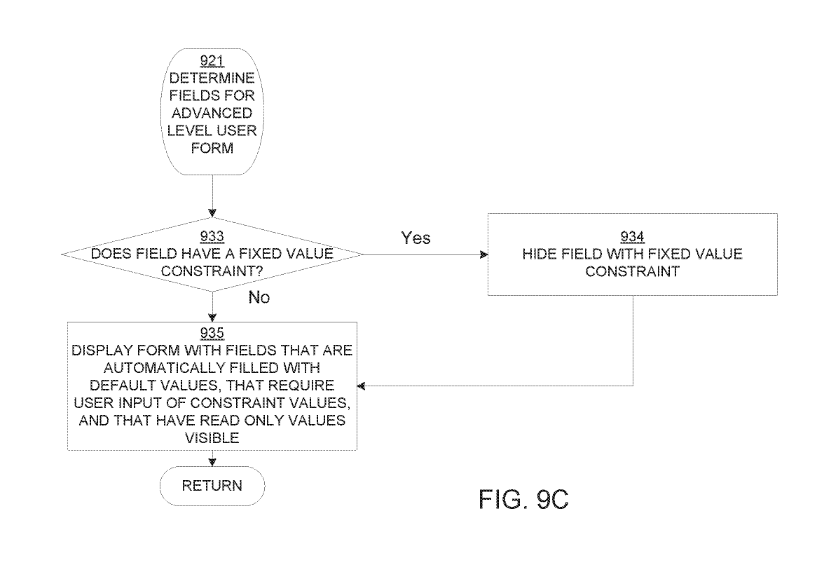

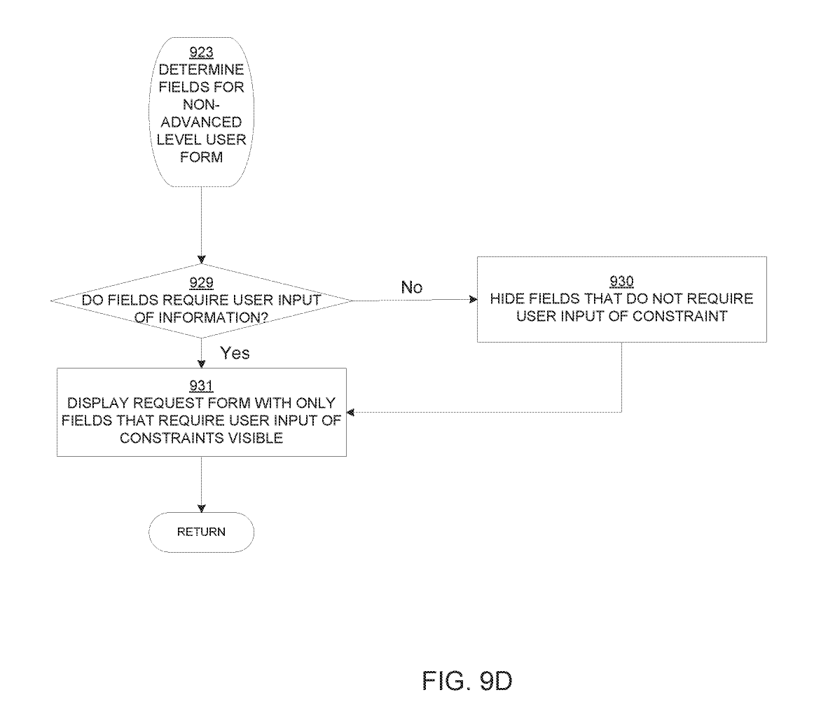

Flowcharts representative of example machine readable instructions that may be executed to implement the example virtual resource provisioning request receiver 701, the example virtual resource provisioning request form determiner 703, the example virtual resource provisioning request form data receiver 705, the example virtual resource provisioning request form expander 707 and the example virtual resource provisioner 709 and/or, more generally, the example system 150 of FIGS. 1 and 7 are shown in FIGS. 8 and 9A-9D. In these examples, the machine readable instructions implement programs for execution by a processor such as the processor 1012 shown in the example processor platform 1000 discussed below in connection with FIG. 10. The programs may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example programs are described with reference to the flowcharts illustrated in FIGS. 8 and 9A-9D, many other methods of deploying, evaluating, and installing services on component servers in accordance with the teachings of this disclosure may alternatively be used. For example, the order of execution of the blocks may be changed, and/or some of the blocks described may be changed, eliminated, or combined.

As mentioned above, the example processes of FIGS. 8 and 9A-9D may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. In some examples, the example processes of FIGS. 8 and 9A-9D may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. Comprising and all other variants of “comprise” are expressly defined to be open-ended terms. Including and all other variants of “include” are also defined to be open-ended terms. In contrast, the term consisting and/or other forms of consist are defined to be close-ended terms.

FIG. 8 depicts a flowchart representative of computer readable instructions that may be executed to implement the system 150 for generation of user interface virtual resource provisioning request forms. An example program 800 is illustrated in FIG. 8.

Initially, virtual resource provisioning request receiver 701 receives a request for a virtual resource provisioning request form that is associated with a resource blueprint (block 801). In one example, virtual resource provisioning request receiver 701 receives requests that are input to a user interface, such as a user interface of a virtual resource management system 100. In one example, the request can be made by a user, such as a user desiring to provision a virtual resource. In one example, the user can enter data into a field or fields of the user interface of the virtual resource management system, in order to make the request for the virtual resource provisioning request form. In one example, the user can be an advanced user or a non-advanced user. In one example, an advanced user may have an advanced understanding of provisioning virtual resources using a virtual resource management system. In one example, a non-advanced user may have a less advanced understanding of provisioning virtual resources using a virtual resource management system. In one example, the input initiates an automated virtual resource provisioning request form retrieval/generation process.

The virtual resource provisioning request form determiner 703 generates the fields that are to be included in a virtual resource request form 171, 173 or 175 (FIG. 2) and the organization of the virtual resource request form 171, 173 or 175 (FIG. 2) that is to be presented to a user/form requester 187 or 189 (FIG. 2) (block 803). The virtual resource provisioning request form 171, 173 or 175 (FIG. 2) that is produced in this process is then provided for display to the user/form requestor. In one example, virtual resource provisioning request form determiner 803 generates the virtual resource provisioning request form 171, 173 or 175 (FIG. 2) by determining the fields that are to be included in the virtual resource provisioning request form. In one example, the fields that are to be included in the virtual resource provisioning request form 171, 173 or 175 (FIG. 2) are based on the blueprint 128 (FIG. 2) that is associated with the request for the virtual resource provisioning request form 171, 173 or 175 (FIG. 2).

Virtual resource provisioning request form data receiver 705 receives initial virtual resource provisioning request form inputs from one or more fields of the virtual resource provisioning request form (block 805). In some examples, the inputs are related to the provisioning and can include data that indicates whether or not the form should be expanded to show and/or otherwise provide access to additional fields. For example, the initial inputs can indicate that optional components are to be provisioned. In some examples, virtual resource provisioning request form data receiver 705 receives inputs (e.g., a virtual resource blueprint request and an indicator of the experience level of the user/form requestor) that can be used to determine the ultimate makeup of the virtual resource provisioning request form 171, 173 or 175 (FIG. 2).

The virtual resource provisioning request form expander 707 determines whether to expand the virtual resource provisioning request form 171, 173 or 175 (FIG. 2) based on the initial virtual resource provisioning request form input (block 807). The virtual resource provisioning request form expander 707 receives information from the virtual request form data receiver 705 (such as a virtual resource blueprint request and an indicator of the experience level of the user/form requestor) and determines if the virtual resource provisioning request form 171, 173 or 175 (FIG. 2) should be expanded or remain in shortened form. For example, if initial input into the virtual resource provisioning request form indicates that the user/requester desires the inclusion of optional components, then virtual resource provisioning request form expander 707 can identify fields corresponding to the optional components and expand the virtual provisioning request form to include those fields. In one example, the optional fields can include fields that require user input of values (e.g., mandatory), fields having a fixed value constraint(s), fields having a default constraint and fields that have read only constraints. In some examples, optional components can themselves have optional components that have corresponding fields. In some examples, the capacity to expand virtual resource provisioning request forms extends the advantages of the automated virtual resource provisioning request form production described herein to optional components. The capacity to expand the virtual resource provisioning request form adds an additional level of automation to the automated virtual resource provisioning request form production described herein. The user/requester can complete a virtual resource provisioning request by entering information into the fields that were added by the expanding of the virtual resource provisioning request form 171, 173 or 175 (FIG. 2) and causing an instantiation of the operation of virtual resource provisioner 709 (e.g., by user interaction with the displayed form) based on the completed form.

If the virtual resource provisioning request form expander 707 determines that the virtual resource provisioning request form 171, 173 or 175 (FIG. 2) is to be expanded, then control passes to block 808, and the virtual resource provisioning request form 171, 173 or 175 (FIG. 2) is expanded. If the virtual resource provisioning request form expander 707 determines that the virtual resource provisioning request form 171, 173 or 175 (FIG. 2) is not to be expanded, then control passes to block 809.

At block 809, the virtual resource provisioning request form data receiver 705 receives virtual resource provisioning request form inputs such as virtual resource provisioning values that complete the entry of information into the virtual resource provisioning request form.

The virtual resource provisioner 709 provisions virtual resources based on provisioning inputs that are placed into the fields of the virtual resource provisioning request form (block 811). The virtual resource provisioner 709 provisions virtual resources in response to accessing the inputs that are provided from the completed virtual resource provisioning request form. Provisioning includes but is not limited to instantiating and configuring certain virtual resources such as virtual machines (VMs), containers, operating systems, virtual appliances, virtual servers, etc., according to the configuration for the blueprint 128 specified in the virtual resource provisioning request form 171, 173 or 175 (FIG. 2). One or more default and/or user input values can be used to instantiate and configure the virtual resource depending upon the type of form 300, 400 used. In some examples, when the request form is filled and submitted by the user, there may be a field validation process that ensures that the provided data does not violate any field constraints that are defined when the request form is generated, e.g., whether all required input fields are filled with a value that is within the defined range, and the custom field validation with regular expression also passes. In some examples, if form validation is successful, the virtual resource provisioning request is accepted by the system and the provisioning process is started.

The provisioned virtual resource can be deployed as directed by the provisioner 709. Virtual resource provisioner 709 effects the provisioning of virtual resources whose provisioning is directed by both advanced and non-advanced provisioners.

For example, the provisioner 709 parses the form 171, 173, 175 to extract information from fields in the form 171, 173, 175. The provisioner 709 determines what information is being provided by the form 171, 173, 175 and what information is to be used by default to provision the requested virtual computing resources, for example. The values are used to provision and configure one or more virtual resources.

FIG. 9A provides further detail regarding an example implementation of block 803 of FIG. 8. FIG. 9A depicts a flowchart representative of computer readable instructions that may be executed to implement operations of an example method for generating user interface virtual resource provisioning request forms (block 803). The virtual resource provisioning request form determiner 701 accesses the fields corresponding to a blueprint (block 901). The virtual resource provisioning request form determiner 701 associates labels with input fields (block 903) based on the blueprint schema for the virtual resource. The virtual resource provisioning request form determiner 701 associates tool tips with input fields (block 905) that provide information that may be useful to a user/requestor. For example, a tooltip can explain how the information that is placed in and/or populates an input field is to be used.

The virtual resource provisioning request form determiner 701 determines if fields have default constraints (block 907). In some examples, virtual resource provisioning request form determiner 701 determines if fields have default constraints based on the form schema associated with the virtual resource to be provisioned. Each component of the virtual resource has a predefined schema that describes the data that is to be provided in the fields of the virtual resource provisioning request form that is used to provision the virtual resource. If the virtual resource provisioning request form determiner 701 determines that a field has a default constraint(s), the virtual resource provisioning request form determiner 701 causes the input field to be presented with a default value (block 908). For example, if a field does not require user input and does not have a fixed value the virtual request form determiner 701 can cause the input field to be presented with a default value. If virtual resource provisioning request form determiner 701 determines that a field does not have a default constraint, control passes to block 909.

The virtual resource provisioning request form determiner 701 determines if a field has permissible values (block 909). In some examples, virtual resource provisioning request form determiner 701 determines if fields have permissible values based on the form schema associated with the virtual resource to be provisioned. If virtual resource provisioning request form determiner 701 determines that a field has permissible values, virtual resource provisioning request form determiner 701 causes the input field to be presented with the permissible values displayed (block 910). For example, virtual resource provisioning request form determiner 701 can cause the input field to be presented with the permissible values that are authorized to be displayed by the form schema associated with the virtual resource to be provisioned. If virtual resource provisioning request form determiner 701 determines that a field does not have permissible values constraints, control passes to block 911.

The virtual resource provisioning request form determiner 701 determines if a field is multivalued (block 911). In some examples, virtual resource provisioning request form determiner 701 determines if a field is multivalued based on the form schema associated with the virtual resource to be provisioned. If virtual resource provisioning request form determiner 701 determines that a field is multivalued, virtual resource provisioning request form determiner 701 causes multivalued selections to be enabled (block 912). For example, virtual resource provisioning request form determiner 701 can cause multivalued selections to be enabled that are authorized to be enabled by the form schema associated with the virtual resource to be provisioned. If virtual resource provisioning request form determiner 701 determines that a field is not multivalued, control passes to block 913.

The virtual resource provisioning request form determiner 701 determines if a field is dependent on another field (block 913). In some examples, virtual resource provisioning request form determiner 701 determines if a field is dependent on another field based on the form schema associated with the virtual resource to be provisioned. If the virtual resource provisioning request form determiner 701 determines that a field is dependent on another field, virtual resource provisioning request form determiner 701 causes the field to be hidden (block 914). For example, virtual resource provisioning request form determiner 701 can cause the field to be hidden if it is indicated that the field should be hidden by the form schema associated with the virtual resource to be provisioned. If the virtual resource provisioning request form determiner 701 determines that a field is not to be hidden, control passes to block 919.

FIG. 9B provides further detail regarding an example implementation of block 803 of FIG. 8. FIG. 9B depicts a flowchart representative of computer readable instructions that may be executed to implement operations of an example method for generating user interface virtual resource provisioning request forms.

Virtual resource provisioning request form determiner 701 determines if the user is experienced, e.g., advanced or non-advanced (block 919). If the virtual resource provisioning request form determiner 701 determines that a user is advanced, virtual resource provisioning request form determiner 701 causes the production of an advanced level virtual resource provisioning request form (block 921). If the virtual resource provisioning request form determiner 701 determines that a user is not advanced, virtual resource provisioning request form determiner 701 causes the production of a non-advanced level virtual resource provisioning request form (block 923). Virtual resource provisioning request form determiner 701 produces the virtual resource provisioning request form (block 925).

FIG. 9C provides implementation details of block 921. For example, FIG. 9C depicts a flowchart representative of computer readable instructions that may be executed to implement operations of block of 921.

The virtual resource provisioning request form determiner 701 determines if a field has a fixed value constraint (block 933). If the virtual resource provisioning request form determiner 701 determines that a field has a fixed value constraint, virtual resource provisioning request form determiner 701 causes the field that has the fixed value constraint to be hidden (block 934). For example, virtual resource provisioning request form determiner 701 can cause the field to be hidden if it is indicated that the field should be hidden by the form schema associated with the virtual resource to be provisioned. If the virtual resource provisioning request form determiner 701 determines that a field does not have a fixed value constraint, control passes to block 935. The virtual resource provisioning request form determiner 701 causes a virtual resource provisioning request form to be displayed to include the full range of available fields except fields with fixed value constraints (block 935). In some examples, respective fields or sets of fields of the full range of available fields can be displayed on separate pages of the virtual resource provisioning request form. In other examples, fields of the full range of available fields can be displayed on a single page of the virtual resource provisioning request form.

FIG. 9D provides implementation details of block 923. FIG. 9D depicts a flowchart representative of computer readable instructions that may be executed to implement operations of block 923.

The virtual resource provisioning request form determiner 701 determines if a field requires the input of information (block 929). If the virtual resource provisioning request form determiner 701 determines that a field does not require the input of information, the field is hidden (block 930). For example, virtual resource provisioning request form determiner 701 can determine if a field does not require the input of information and cause the field to be hidden if it is indicated that the field does not require the input of information and should be hidden by the form schema associated with the virtual resource to be provisioned. If the virtual resource provisioning request form determiner 701 determines that a field requires the input of information, control passes to block 935. At block 935, the virtual resource provisioning request form determiner 701 causes a virtual resource provisioning request form to be displayed having only fields that require user input of information. For example, virtual resource provisioning request form determiner 701 can cause a virtual resource provisioning request form to be displayed having only fields that require user input of information if it is indicated that a virtual resource provisioning request form should be displayed having only fields that require user input of information by the form schema associated with the virtual resource to be provisioned.

FIG. 10 is a block diagram of an example processor platform 1000 capable of executing the instructions of FIGS. 8 and 9A-9D to implement the example systems and operation of FIG. 7. The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache), and executes instructions to implement the example system 150 or portions thereof, such as the example virtual resource provisioning request receiver 701, the example virtual resource provisioning request form determiner 703, the example virtual resource provisioning request form data receiver 705, the example virtual resource provisioning request form expander 707 and the example virtual resource provisioner 709. The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include flash devices, floppy disk drives, hard drive disks, optical compact disk (CD) drives, optical Blu-ray disk drives, RAID systems, and optical digital versatile disk (DVD) drives.

Coded instructions 1032 representative of the example machine readable instructions of FIGS. 8 and 9A-9D may be stored in the mass storage device 1028, in the volatile memory 1014, in the non-volatile memory 1016, and/or on a removable tangible computer readable storage medium such as a CD or DVD.

In certain examples, the processor 1012 can be used to implement the example virtual resource provisioning request receiver 701, the example virtual resource provisioning request form determiner 703, the example virtual resource provisioning request form data receiver 705, the example virtual resource provisioning request form expander 707 and the example virtual resource provisioner 709, etc. In certain examples, as discussed herein, the hardware of processor 1012 is virtualized using virtualization such as VMs and/or containers. In the example of FIG. 10, the example virtual resource provisioning request receiver 701, the example virtual resource provisioning request form determiner 703, the example virtual resource provisioning request form data receiver 705, the example virtual resource provisioning request form expander 707 and the example virtual resource provisioner 709 can be implemented by one or more VMs or containers, so as to virtualize the hardware of processor 1012.

Thus, certain examples facilitate improved provisioning of virtual computing resources through dynamic generation of new interfaces with provisioning request forms. Certain examples provide a technological improvement of more reliable resource provisioning by enabling an advanced user to customize a request form and resulting virtual resource while helping to ensure that a novice or non-advanced user does not incorrectly provision a resource that will be unusable for its intended purpose. As opposed to prior request technology, certain examples dynamically and intelligently generate provisioning request forms that adapt to user context, application context, and environment to provide robust, reliable virtual resource generation and configuration.

Certain examples provide a method for generating user interface request forms for provisioning virtual resources, the method comprising, receiving a request for a virtual resource provisioning request form that is associated with a virtual resource blueprint, determining the virtual resource provisioning request form and presenting the virtual resource provisioning request form for display, receiving initial virtual resource provisioning request form provisioning information in one or more fields of the virtual resource provisioning request form, determining whether to expand the virtual resource provisioning request form based on the initial virtual resource provisioning request form provisioning information, receiving data that completes an input of the provisioning information into the virtual resource provisioning request form, and in response to the completion of the input of the provisioning information into the virtual resource provisioning request form, provisioning the virtual resource.

In some examples, determining the virtual resource provisioning request form includes determining whether a user is advanced or non-advanced based on the request for virtual resource provisioning request form. In some examples, responsive to determining whether a user is advanced or non-advanced, fields to be included in the virtual resource provisioning request form are determined. In some examples, determining fields to be included in the virtual request form, for an advanced user, includes determining if a field has a fixed value constraint. In some examples, determining fields to be included in the virtual request form, for a non-advanced user, includes determining if a field requires a user input of information. In some examples, determining the virtual resource provisioning request form includes accessing fields corresponding to the virtual resource blueprint. In some examples, determining the virtual resource provisioning request form includes determining if a first field is dependent on a second field.

Certain examples provide an apparatus for generating user interface request forms for provisioning virtual resources, the apparatus comprising, a request receiver to receive a request for a virtual resource provisioning request form that is associated with a virtual resource blueprint, a virtual resource request form determiner to determine the virtual resource provisioning request form and presenting the virtual resource provisioning request form for display, an initial input receiver to receive initial virtual resource provisioning request form provisioning constraints in one or more fields of the virtual resource provisioning request form, a determiner to determine whether to expand the virtual resource provisioning request form based on the initial virtual resource provisioning request form provisioning information, a data receiver to receive data that completes an input of the provisioning information into the virtual resource provision request form, and a virtual resource provisioner to provision the virtual resource in response to the completion of the input of the provisioning information into the virtual resource provisioning request form.

Certain examples provide a computer readable storage medium comprising instructions that, when executed, cause a machine to at least: receive a request for a virtual resource provisioning request form that is associated with a virtual resource blueprint, determine the virtual resource provisioning request form and presenting the virtual resource provisioning request form for display, receive initial virtual resource provisioning request form provisioning information in one or more fields of the virtual resource provisioning request form, determine whether to expand the virtual resource provisioning request form based on the initial virtual resource provisioning request form provisioning information, receive data that completes an input of the provisioning information into the virtual resource provision request form, and in response to the completion of the input of the provisioning information into the virtual resource provisioning request form, provision the virtual resource based on request form information.

From the foregoing, it will be appreciated that the above disclosed methods, apparatus and articles of manufacture for generation of user interface request forms for provisioning virtual resources include examples as described herein.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method for generating user interface request forms for provisioning virtual resources, the method comprising:
receiving a request for a virtual resource provisioning request form that is associated with a virtual resource blueprint;
determining the virtual resource provisioning request form and presenting the virtual resource provisioning request form for display;
receiving initial virtual resource provisioning request form provisioning information in one or more fields of the virtual resource provisioning request form;
determining whether to expand the virtual resource provisioning request form based on the initial virtual resource provisioning request form provisioning information;
receiving information that completes an input of the virtual resource provisioning information into the virtual resource provisioning request form; and
in response to the completion of the input of information into the virtual resource provisioning request form, provisioning the virtual resource.

2. The method of claim 1, wherein determining the virtual resource provisioning request form includes determining whether a user is advanced or non-advanced based on the request for virtual resource provisioning request form.

3. The method of claim 2, wherein responsive to determining whether a user is advanced or non-advanced determining fields to be included in the virtual resource provisioning request form.

4. The method of claim 3, wherein determining fields to be included in the virtual request form, for an advanced user, includes determining if a field has a fixed value constraint.

5. The method of claim 3, wherein determining fields to be included in the virtual request form, for a non-advanced user, includes determining if a field requires user input.

6. The method of claim 1, wherein determining the virtual resource provisioning request form includes accessing fields corresponding to the virtual resource blueprint.

7. The method of claim 1, wherein determining the virtual resource provisioning request form includes determining if a first field is dependent on a second field.

8. An apparatus for generating user interface request forms for provisioning virtual resources, the apparatus comprising:
a request receiver to receive a request for a virtual resource provisioning request form that is associated with a virtual resource blueprint;
a virtual resource request form determiner to determine the virtual resource provisioning request form and presenting the virtual resource provisioning request form for display;
an initial input receiver to receive initial virtual resource provisioning request form provisioning information in one or more fields of the virtual resource provisioning request form;
a determiner to determine whether to expand the virtual resource provisioning request form based on the initial virtual resource provisioning request form provisioning information;
a data receiver to receive data that completes an input of the provisioning information into the virtual resource provision request form; and
a virtual resource provisioner to provision the virtual resource in response to the completion of the input of the provisioning information into the virtual resource provisioning request form.

9. The apparatus of claim 8, wherein determining the virtual resource provisioning request form includes determining whether a user is advanced or non-advanced based on the request for virtual resource provisioning request form.

10. The apparatus of claim 9, wherein responsive to determining whether a user is advanced or non-advanced determining fields to be included in the virtual resource provisioning request form.

11. The apparatus of claim 10, wherein determining fields to be included in the virtual request form, for an advanced user, includes determining if a field has a fixed value constraint.

12. The apparatus of claim 10, wherein determining fields to be included in the virtual request form, for a non-advanced user, includes determining if a field requires user input.

13. The apparatus of claim 8, wherein determining the virtual resource provisioning request form includes accessing fields corresponding to the virtual resource blueprint.

14. The apparatus of claim 8, wherein determining the virtual resource provisioning request form includes determining if a first field is dependent on a second field.

15. A computer readable storage medium comprising instructions that, when executed, cause a machine to at least:
receive a request for a virtual resource provisioning request form that is associated with a virtual resource blueprint;
determine the virtual resource provisioning request form and presenting the virtual resource provisioning request form for display;
receive initial virtual resource provisioning request form provisioning information in one or more fields of the virtual resource provisioning request form;
determine whether to expand the virtual resource provisioning request form based on the initial virtual resource provisioning request form provisioning information;
receive data that completes an input of the provisioning information into the virtual resource provision request form; and
in response to the completion of the input of the provisioning information into the virtual resource provisioning request form, provision the virtual resource.

16. The computer readable storage medium of claim 15, wherein determining the virtual resource provisioning request form includes determining whether a user is advanced or non-advanced based on the request for virtual resource provisioning request form.

17. The computer readable storage medium of claim 16, wherein responsive to determining whether a user is advanced or non-advanced determining fields to be included in the virtual resource provisioning request form.

18. The computer readable storage medium of claim 17, wherein determining fields to be included in the virtual request form, for an advanced user, includes determining if a field has a fixed value constraint.

19. The computer readable storage medium of claim 17, wherein determining fields to be included in the virtual request form, for a non-advanced user, includes determining if a field requires user input.

20. The computer readable storage medium of claim 15, wherein determining the virtual resource provisioning request form includes accessing fields corresponding to the virtual resource blueprint.
